(19) United States
(12) Patent Application Publication
(10) Pub. No.: US 2009/0022842 A1
(43) Pub. Date: Jan. 22, 2009

(54) INJECTOR FOR INJECTION-MOULDING OF PLASTIC MATERIALS

(75) Inventors: Marco SALVADOR, Treviso (IT); Peter DAL BO, Treviso (IT)

Correspondence Address: HESLIN ROTHENBERG FARLEY & MESITI PC, 5 COLUMBIA CIRCLE, ALBANY, NY, 12203, US

(73) Assignee: INGLASS S.p.A., Treviso (IT)

(21) Appl. No.: 11/866,503

(22) Filed: Oct. 3, 2007

(30) Foreign Application Priority Data
Oct. 6, 2006 (IT) TO2006A000716

(51) Int. Cl. B29C 45/20

(52) U.S. Cl. 425/549

(57) ABSTRACT

An injector for injection-moulding of plastic materials including a generally cylindrical body, wound on the outside of which are at least two pairs of mutually independent electrical heating resistors and associated to which are respective control thermocouples.

### CROSS-REFERENCE TO RELATED APPLICATIONS

This application claims priority from Italian Patent Application No. TO2006A000716 filed Oct. 6, 2006, the entire disclosure of which is incorporated herein by reference.

### FIELD OF THE INVENTION

The present invention relates in general to injection-moulding (or injecto-compression moulding) of plastic materials, and regards more in particular an injector of the type comprising a generally cylindrical body with a proximal end and a distal end, a central channel for passage of the plastic material to be injected towards said proximal end, electrical-heater means wound on the outer surface of the body, and control-thermocouple means operatively associated to the electrical-heater means.

### STATE OF THE PRIOR ART

An injector for injection-moulding of plastic materials of the type defined above is known from the documents Nos. U.S. Pat. No. 6,394,784, U.S. Pat. No. 6,561,789 and U.S. Pat. No. 6,761,557, all of which filed in the name of Mold-Masters Limited. In these documents (with particular reference to FIG. 5), the electrical-heater means are constituted by a first resistor and a second resistor, which are mutually independent, wound over the entire length of the body of the injector, i.e., from its proximal end to its distal end and incorporated within respective layers of insulating dielectric material that coat the outer surface of the body of the injector.

With this arrangement, the two heating resistors are necessarily situated at different radial distances (i.e., respectively smaller and greater) from the central channel of passage of the plastic material to be injected. The fail-safe function, provided by the duplication of the electrical-heater system, is in this case inadequate given that the thermal effect resulting from the activation of one or other resistor on the plastic material to be injected is evidently other than uniform, a fact that constitutes a serious drawback.

To solve this problem there has been proposed, in the document No. EP-B-1252998 (with particular reference to FIG. 2), the use of two electrical heating resistors, which are housed in a spiral-shaped groove, which are provided on the inner surface of the body of the injector and can also be activated independently of one another. With this arrangement, the two resistors are both situated at the same radial distance from the central channel of the injector so that in the case of breakdown of one resistor the thermal effect obtained by activation of the other resistor is substantially identical, apart from a slight difference deriving from the fact that, since they are axially set on top of one another, they do not extend along the same axial extension of the body of the injector from its proximal end to its distal end. In fact, one of the two resistors starts in a position axially closer to the distal end and terminates in a position axially further away from the proximal end than the other resistor.

This arrangement, albeit far more effective for the purposes of fail-safe function as compared to the patents filed in the name of Mold-Masters Limited referred to above, does not take into account the fact that, in the use of the injector, the area of its proximal end (in contact with the colder mould) is subject to a greater thermal dissipation as compared to the remaining part of the injector.

### SUMMARY OF THE INVENTION

The purpose of the present invention is to improve in this regard the solution generally known from the already cited document No. EP-B-1252998, and more in particular to optimize—in the framework of fail-safe function—the control of temperature along different axial areas of the injector.

With a view to achieving said purpose, the object of the present invention is an injector for injection-moulding of plastic materials corresponding to the preamble of claim 1, the primary characteristic of which lies in the fact that it comprises at least one first pair and one second pair of said resistors, the first pair of resistors extending from said distal end along a first axial portion of the body of the injector, and the second pair of resistors extending from said proximal end along a second axial portion of the body of the injector, each pair of said resistors being operatively independent of the other pair.

Preferably, the axial extension of said first axial portion of the body of the injector is greater than that of said second axial portion, and the distance between the coils of the resistors of the second pair is conveniently smaller than the distance between the coils of the resistors of the first pair.

In a first embodiment of the invention, the first pair of resistors is housed within a first spiral-shaped groove of said body of the injector, formed between said distal end up to the proximity of a generally intermediate area, and the second pair of resistors is housed within a second spiral-shaped groove of the body formed between said generally intermediate area and the proximal end of the body.

Either or both of the two spiral-shaped grooves can be formed directly on the outer surface of the body of the injector or else, alternatively, also on a tubular element distinct from the body of the injector and axially inserted on this in thermal contact.

In a variant of the invention, the resistors of the first pair and of the second pair are pre-wound in respective spiral-shaped configurations and then fitted axially on the outer surface of the body of the injector. In this case, there can be provided axial retention means for retaining each pair of resistors with respect to said body of the injector, and the resistors of the first pair and of the second pair can be pre-wound within respective sleeves inserted coaxially on the body of the injector.

In any case, the injector according to the invention can moreover comprise at least one third pair of independent resistors, set between the first pair and said second pair of resistors and equipped with autonomous control thermocouples.

The injector according to the invention is thus in practice advantageously equipped with two or more distinct and separate areas of fail-safe control of the temperature, of which the one corresponding to its proximal end ensures a higher density of energy for heating better the area of the point of injection within the mould, in which there is also greater dissipation. In the second area, and possibly in the further areas that are located in the central area and towards the distal end of the injector, the thermal dissipation is lower, and hence the power requirement can be lower.

In practice then, none of the electrical heaters of the injector according to the invention is wound over the entire axial length of the body of the injector, unlike what is instead expressly envisaged in the patents held by Mold-Masters Limited mentioned previously.

Either or both of the two spiral-shaped grooves can be formed directly on the outer surface of the body of the injector or else, alternatively, also on an element distinct from the body of the injector and inserted axially thereon in thermal contact.

### BRIEF DESCRIPTION OF THE DRAWINGS

The invention will now be described in detail with reference to the annexed plates of drawings, which are provided purely by of way of non-limiting example and in which:

FIG. 1 is a schematic illustration in side elevation of an injector for injection-moulding of plastic materials according to the invention;

FIG. 2 is a schematic perspective view showing a first variant of the injector according to the invention;

FIG. 3 is a schematic perspective view showing a second variant of the injector according to the invention;

FIG. 4 is a partial view in longitudinal cross section of FIG. 3; and

FIG. 5 shows a part of FIG. 4 at a larger scale.

### BRIEF DESCRIPTION OF THE DRAWINGS

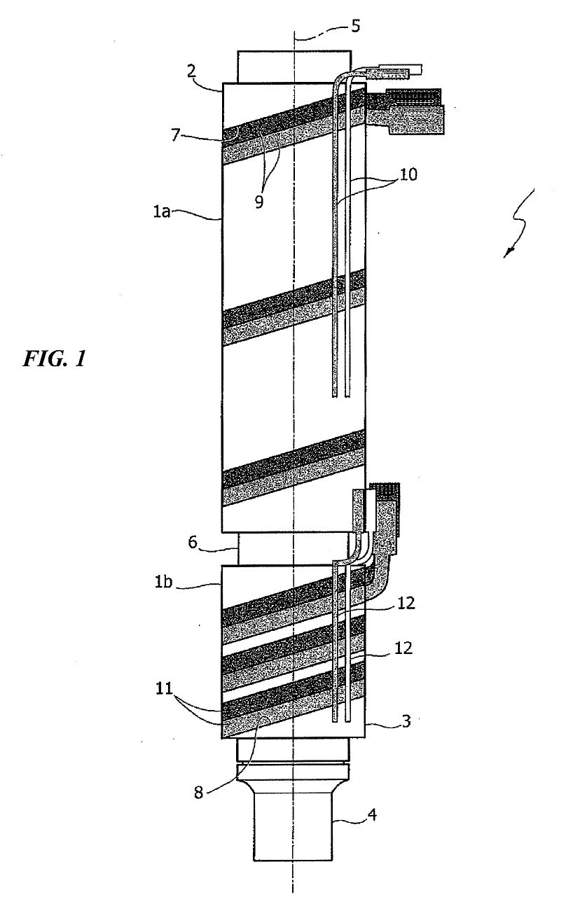

With reference to the drawing of FIG. 1, the reference number 1 designates as a whole an injector for injection moulds of plastic materials, according to a first embodiment of the invention. For reasons of simplicity of illustration, in the drawing only the outer body of the injector 1 is represented, whilst other components (such as the usual valve with axially mobile needle with the corresponding open/close element) are omitted.

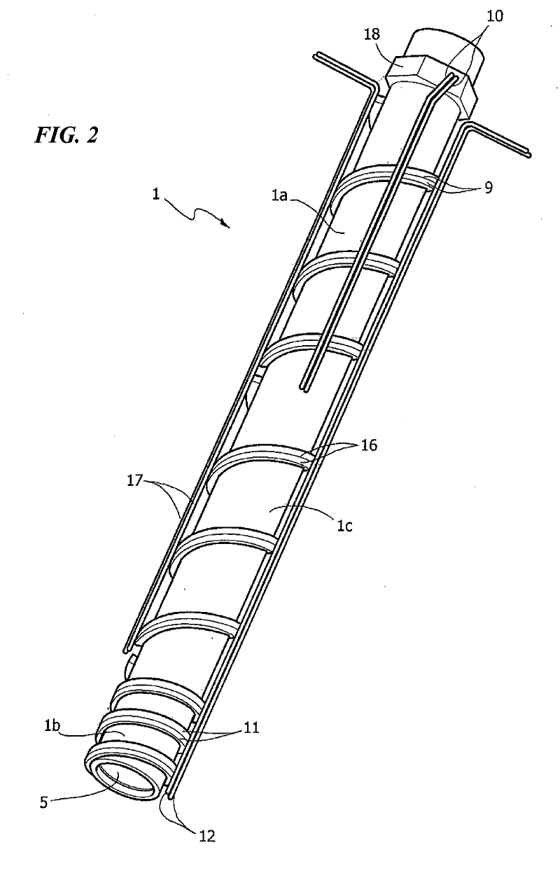

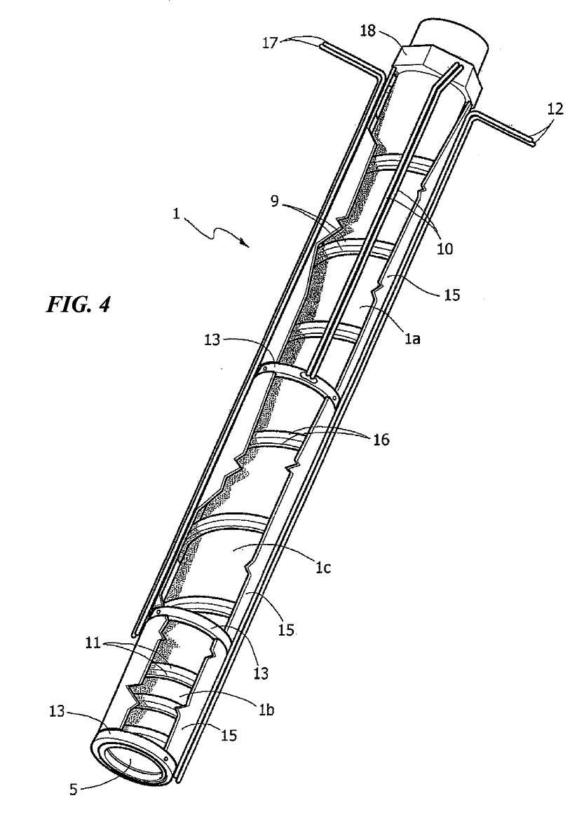

The body of the injector 1, which has a generally cylindrical shape, has a distal end 2 and a proximal end 3, which bears, in a generally conventional way, a nozzle tubular terminal or tip, designated as a whole by 4, which is also of a known type, designed to co-operate in a sealed way with the injection passage of a mould. The nozzle tip 4 is in communication with a central axial channel 5 of the injector 1 (visible in FIGS. 2 to 5), which defines a passage for the fluid plastic material to be injected.

The body of the injector 1 is ideally divided, by a generally intermediate portion 6 of reduced cross section, in one first portion 1a, which extends from the distal end 2 up to the intermediate area 6, and one second portion 1b, which extends beyond said intermediate area 6 up to the proximal end 3.

Each portion 1a, 1b is made, on its outer wall, with a generally spiral-shaped groove 7, 8, respectively: in view of the fact that the first portion 1a has an axial extension greater than the axial extension of the second portion 1b, the axial extension of the spiral-shaped groove 7 is accordingly larger than that of the spiral-shaped groove 8. In the case of the example illustrated, the axial extension of the groove 7 is more than twice that of the groove 8, whilst the number of coils is, once again, in the case of the example illustrated, three for each. The axial distance between the coils of the groove 7 is hence in this case considerably greater than that between the coils of the groove 8. In general terms, the axial distance between the coils of the groove 8 may be, for example, from two to six times smaller than that between the coils of the groove 7.

Of course these proportions may vary according to the global axial dimension of the injector.

Housed within the spiral-shaped groove 7 is a first pair of electrical heating resistors 9, which can be activated jointly or else, more conveniently, even independently of one another, and to which respective autonomous control thermocouples 10 are operatively associated.

Likewise, the spiral-shaped groove 8 houses a pair of electrical heating resistors 11, which can also conveniently be activated independently of one another and are equipped with respective autonomous control thermocouples 12.

With this arrangement, the injector 1 according to the invention is in practice has two distinct and mutually independent areas for control, with fail-safe function, of the temperature of the plastic material that in use flows through the central channel identified by the axis 5. The first area, corresponding to the portion 1b with the spiral-shaped groove 8, close to the nozzle tip 4 and hence to the inlet of the mould, is equipped with the two heating resistors 11 with coils set close to one another and hence with higher density of thermal energy to be able to heat in a more effective way the area of the point of injection, in which also the greater dissipation occurs. The portion 1a, with the spiral-shaped groove 7 and the two resistors 9, defines the second area of control of the temperature, which is independent of the first area and has a lower density of thermal energy in so far as it is further away from the injection point.

The resistors 9, with the corresponding thermocouples 10, and the resistors 11, with the corresponding thermocouples 12, will be connected, with generally conventional modalities, to an electronic control unit for thermal regulation.

Of course, the details of construction and the embodiments may vary widely with respect to what is described and illustrated herein, without thereby departing from the scope of the present invention. Thus, for example, even though, in the example described with reference to FIG. 1, the spiral-shaped grooves 7 and 8 are made directly on the outer wall of the body of the injector 1, in a variant (not illustrated) they could be formed on a tubular element, either single or double, fitted axially on the body 1 in contact of thermal transfer therewith.

The pairs of independent resistors, with corresponding control thermocouples, may also number more than two, for example three or more, as in the case of the variants of the invention described more fully hereinafter.

In addition, the resistors 9 and 11 of the one and/or other pair may be activated and controlled, rather than each independently of the other, in a co-ordinated and possibly joint way.

In the case of the variant represented in FIG. 2, where parts that are identical or similar to the ones described previously with reference to FIG. 1 are designated by the same reference numbers, the body of the injector 1 is without grooves. In this case, the resistors of the first pair 9 and of the second pair 11 are pre-wound wound in respective spiral-shaped configurations and are then fitted axially on the outer surface of said body of the injector, for example with radial interference.

Set between the two pairs of resistors 9 and 11, along the intermediate axial portion of the body 1, designated by 1c, is at least one third pair of further independent resistors 16, which are also equipped with respective autonomous control thermocouples 17.

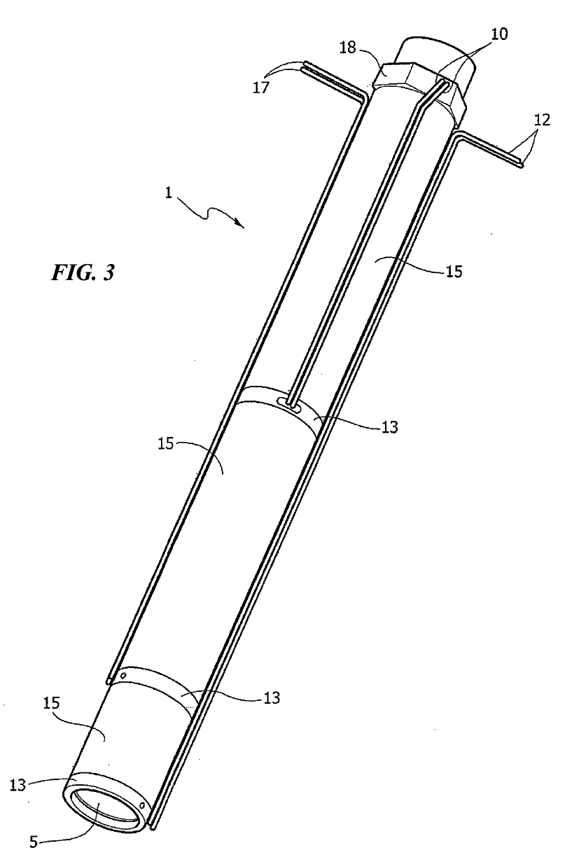

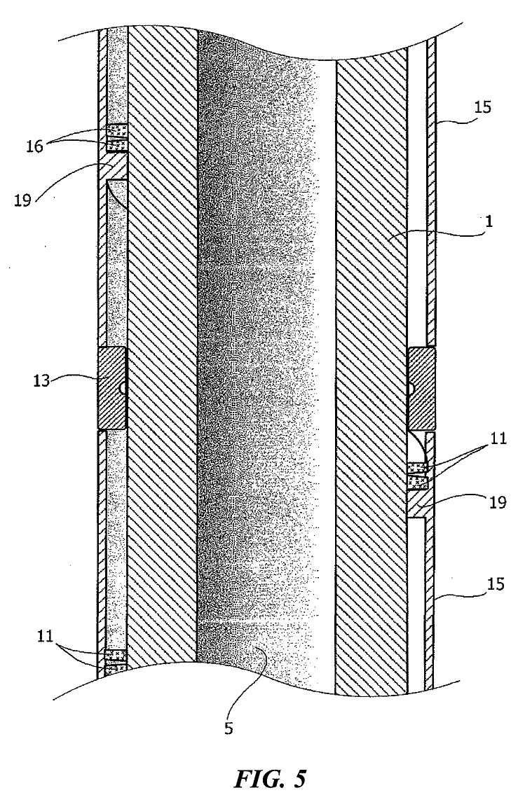

The variant represented in FIGS. 3 to 5 differs from the embodiment of FIG. 2 in that retention members are provided for axial retention of each pair of resistors 9, 11 and 16 with respect to the body of the injector. Said axial retention members can, for example, include clamping rings 13, set directly at the ends of each pair of resistors or else more conveniently, as illustrated, at the ends of respective sleeves 15, which are fitted coaxially on the body 1 of the injector and pre-wound within which are the resistors of the first pair 9, the second pair 11, and the possible third pair 16. As may be seen in detail in FIG. 5, the sleeves 15 can be formed internally with spiral-shaped projections 19, on which the respective resistors of each pair rest, in thermal contact with the outer surface of the body 1.

The clamping rings 13 can also function as members for positioning the control thermocouples 10, 12 and 17 and can be packed axially with the sleeves 15, for example by means of a nut 18 screwed on a thread, in this case provided at the distal end 2 of the body 1 of the injector.

1. An injector for injection-moulding of plastic materials, comprising:
a generally cylindrical body with a proximal end and a distal end;
a central channel for passage of the plastic material to be injected towards said proximal end;
electrical-heater means generally spirally wound around the outer surface of said body;
control-thermocouple means operatively associated to said electrical-heater means, wherein said electrical-heater means include two independent resistors positioned on said body substantially at the same radial distance from said central channel; and
wherein said injector comprises at least one first pair and one second pair of said resistors, the first pair of resistors extending from said distal end along a first axial portion of the body of the injector and the second pair of resistors extending from said proximal end along a second axial portion of the body of the injector, each pair of said resistors being operatively independent of the other pair.

2. The injector according to claim 1, wherein an axial extension of said first axial portion of the body of the injector is greater than a second axial extension of said second axial portion.

3. The injector according to claim 2, wherein an axial extension of said first axial portion of the body of the injector is at least twice a second axial extension of said second axial portion.

4. The injector according to claim 2 wherein a distance between the coils of the resistors of the second pair is smaller than a distance between the coils of the resistors of the first pair

5. The injector according to claim 4, wherein a distance between the coils of the resistors of the second pair is from two to six times smaller than a distance between the coils of the resistors of the first pair.

6. The injector according to claim 2 wherein said resistors of the first pair and of the second pair have a same number of coils.

7. The injector according to claim 1 wherein each pair of said resistors comprises at least one autonomous control thermocouple.

8. The injector according to claim 7, wherein each resistor of each pair comprises an autonomous control thermocouple.

9. The injector according to claim 1 wherein said first pair of resistors is housed within a first spiral-shaped groove of said body formed between said distal end up to the proximity of a generally intermediate area of said body, and said second pair of resistors is housed within a second spiral-shaped groove of said body formed between said generally intermediate area of said body and said proximal end.

10. The injector according to claim 9, wherein said generally intermediate area of the body of the injector has a restricted cross section.

11. The injector according to claim 1 wherein said resistors of the first pair and of the second pair are pre-wound in respective spiral-shaped configurations and then fitted axially on the outer surface of said body of the injector.

12. The injector according to claim 11, further comprising axial retention means for retaining each pair of resistors with respect to said body of the injector.

13. The injector according to claim 12, wherein said axial retention means include annular clamping members set at the ends of each pair of resistors.

14. The injector according to claim 13, wherein said annular clamping members function as members for positioning said control-thermocouple means.

15. The injector according to claim 11 wherein said resistors of the first pair and of the second pair are pre-wound within respective sleeves fitted and clamped coaxially on the body of the injector.

16. The injector according to claim 11 further comprising at least one third pair of independent resistors set between said first pair of resistors and said second pair of resistors.

17. The injector according to claim 16, wherein the resistors of said at least one third pair comprise at least one autonomous control thermocouple.

18. The injector according to claim 3, wherein a distance between the coils of the resistors of the second pair is smaller than a distance between the coils of the resistors of the first pair.

19. The injector according to claim 3 wherein said resistors of the first pair and of the second pair have a same number of coils.

20. The injector according to claim 4 wherein said resistors of the first pair and of the second pair have a same number of coils.
